(19) United States
(12) Patent Application Publication
(10) Pub. No.: US 2011/0179618 A1
(43) Pub. Date: Jul. 28, 2011

(54) SUPPORT APPARATUS

(75) Inventors: Dominic Tedesco, Wishaw (GB); William Rutherford, Wishaw (GB)

(73) Assignee: DALGLEN (NO. 1158) LIMITED, Glasgow (UK)

(21) Appl. No.: 13/062,147

(22) PCT Filed: Aug. 28, 2009
(86) PCT No.: PCT/GB2009/051087

§ 371 Date: Mar. 21, 2011

(30) Foreign Application Priority Data
Sep. 3, 2008 (GB) 0816008.7

(51) Int. Cl. B23P 19/00

(52) U.S. Cl. 29/281.4

(57) ABSTRACT

A support apparatus for assembling a frame comprising: a first support member for supporting a first frame member; a second support member spaced apart from the first support member for supporting a second frame member and allowing the first and second frame members to be connected by a third frame member; and rotating means for rotating the first and second support members to allow the first and second frame members to be connected by a fourth frame member.

### FIELD OF THE INVENTION

The present invention relates to a support apparatus for assembling a structural frame. In particular but not exclusively, the present invention relates to a support apparatus for use in the construction of building modules.

### BACKGROUND OF THE INVENTION

The conventional method of constructing buildings on site has a number of disadvantages such as the low speed of construction which can be hampered further by poor weather. It is also known to provide prefabricated buildings but the size of these is limited. It has been found that buildings can be constructed in a modular form. Each box-shaped module can be adapted to provide a “room” or volume of the building, and examples include a kitchen, toilet, and stairway modules and so on. Each module may be fully constructed within a factory and then the various modules may be connected together in situ to form the completed building. Construction within the factory allows assembly line production methods which increase the speed of construction and are not affected by weather conditions.

It is desirable to provide apparatus which assist in this method of constructing the modules. It is desirable to provide support apparatus which can support the modules throughout the various stages of construction and which can assist to increase the speed of construction. It is desirable to provide support apparatus which can support modules that differ in one or more of their length, width and height.

### SUMMARY OF THE INVENTION

According to the present invention there is provided a support apparatus for assembling a frame comprising:
a first support member for supporting a first frame member;
a second support member spaced apart from the first support member for supporting a second frame member and allowing the first and second frame members to be connected by a third frame member; and
rotating means for rotating the first and second support members to allow the first and second frame members to be connected by a fourth frame member.

The first support member may be rotatably mounted to a first stand member. The second support member may be rotatably mounted to a second stand member.

The rotating means may comprise a motor for rotating at least one of the first and second support members. Alternatively or in addition, the rotating means may be manually operated. The rotating means may include gearing.

The support apparatus may include first adjusting means for adjusting the spacing between the first support member and the second support member. One of the first and second stand members may have a fixed position. At least one of the first and second stand members may be movable in a first direction towards and away from the other of the first and second support members. At least one of the first and second stand members may be rollable or slidable in the first direction. At least one of the first and second stand members may be rollable along a rail extending in the first direction.

The first support member may include a first clamp for clamping the first frame member. The first support member may be adapted to clamp two spaced apart columns of the first frame member allowing connection of the columns by one or more beams.

The first clamp may comprise two spaced apart clamping teeth and the distance between the clamping teeth may be adjustable. One or more of the clamping teeth may be mounted to slots provided at the first support member such that moving the or each clamping tooth along the slot adjusts the distance between the clamping teeth.

The second support member may include a second clamp for clamping the second frame member. The second support member may be adapted to clamp two spaced apart columns of the second frame member allowing connection of the columns by one or more beams.

The second clamp may comprise two spaced apart clamping teeth and the distance between the clamping teeth may be adjustable. One or more of the clamping teeth may be mounted to slots provided at the second support member such that moving the or each clamping tooth along the slot adjusts the distance between the clamping teeth. The slots provide second adjusting means.

The support apparatus may include rotational positioning means. The support apparatus may include braking means for braking the rotating first and second support members.

### BRIEF DESCRIPTION OF THE DRAWINGS

Embodiments of the present invention will now be described, by way of example only, with reference to the accompanying drawings:

FIG. 1 is a perspective view of a support apparatus supporting a partially assembled frame;

FIG. 2 is a plan view of the support apparatus of FIG. 1 showing the spacing between the first and second support members;

FIG. 3 is a side view of the first support member of the support apparatus of FIG. 1;

FIG. 4 is a side view of the second support member of the support apparatus of FIG. 1;

FIG. 5 is an end view of the first support member of the support apparatus of FIG. 1;

FIG. 6 is an end view of the first stand member of the support apparatus of FIG. 1; and

FIG. 7 is an end view of the second stand member of the support apparatus of FIG. 1.

### DESCRIPTION

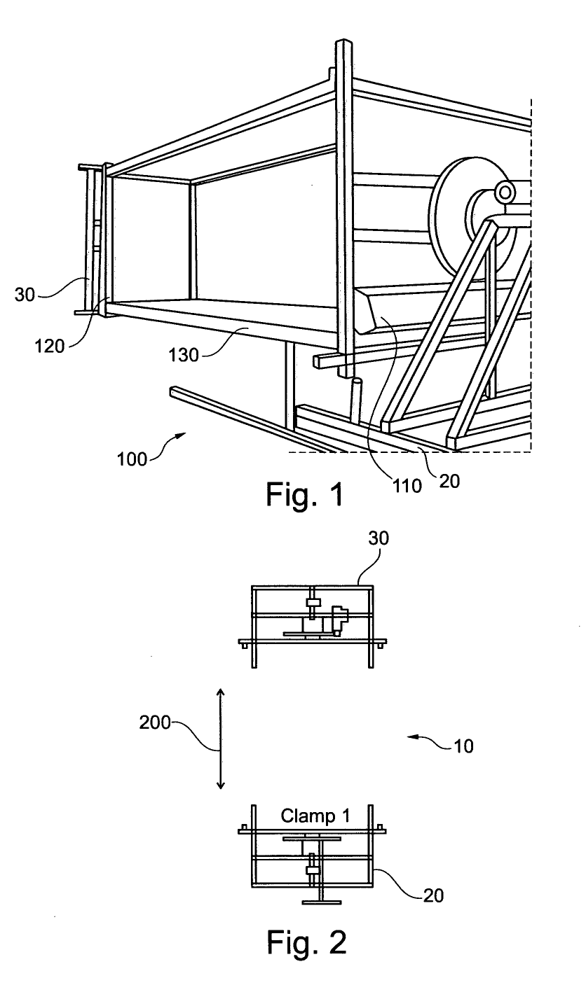

FIG. 1 shows a support apparatus or jig 10 for assembling a frame 100. The jig 10 has a first support member 20 for supporting a vertical first frame member 110 and a second support member 30 which is spaced apart from the first support member 20 and which supports a vertical second frame member 120. This allows the first and second frame members to be connected by a horizontal third frame member 130, such as by welding.

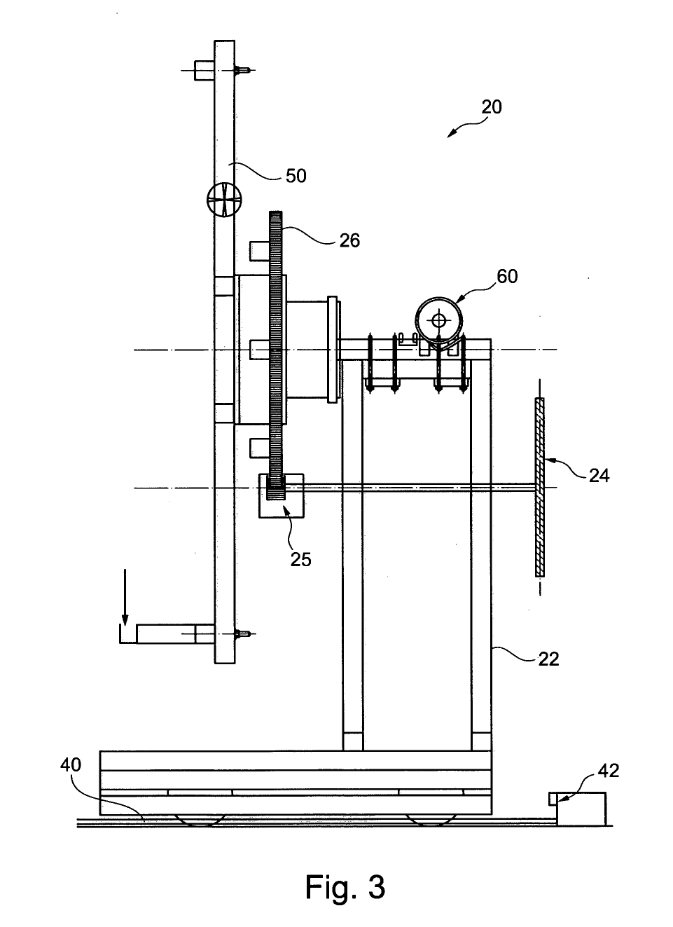

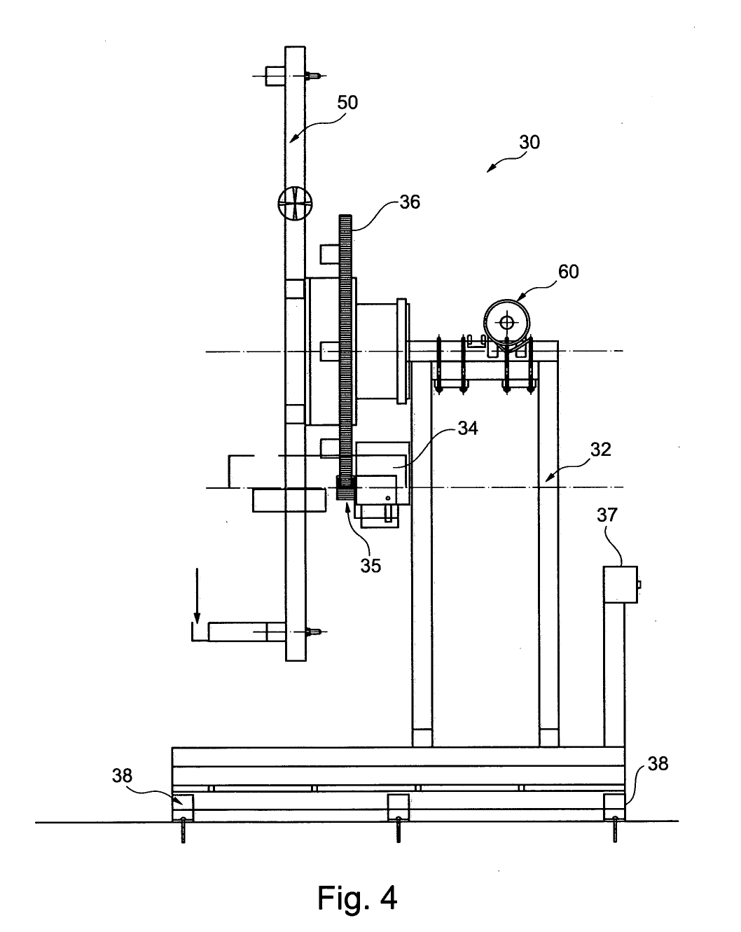

The first support member 20 is rotatably mounted to a first stand member 22 and, similarly, the second support member 30 is rotatably mounted to a second stand member 32. The jig 10 also includes rotating means for rotating the first and second support members relative to their respective stand members. For the first support member 20, as shown in FIG. 3, this comprises a manually operated wheel 24 which turns a cog 25 which turns a gear 26 which is also rotatably mounted to the first stand member 22. For the second support member 30, as shown in FIG. 4, this comprises a motor 34 which drives a cog 35 which turns a gear 36 which is also rotatably mounted to the second stand member 22. A motor operating control 37 is provided which is electronically connected to the motor 34.

The rotating means allows the first and second support members, and thus the supported frame members, to be rotated to any selected rotational position. This allows convenient connection of the first and second frame members by a fourth frame member. Rotation to the desired position provides a convenient working height, such as to weld together the frame members, which increases the speed of construction. The first and second support members can be further rotated, and further frame members and then panel members can be readily connected, until the frame 100 has been completed. This may be, for example, a building module. Another example is the frame for a transport container.

The jig 10 includes first adjusting means for adjusting the spacing between the first support member 20 and the second support member 30. The second stand member 32, and therefore the second support member 30, is fixed to the floor using anchors 38 and so has a fixed position. The first stand member 22, and therefore the first support member 20, is movable in a first direction 200 towards and away from the second support member 30. The first stand member 20 is rollably mounted on a rail 40 which extends in the first direction 200. Adjusting the spacing between the first support member 20 and the second support member 30 allows the jig 10 to be used in the construction of different modules which vary in their length. A stop 42 is provided for limiting the travel of the first stand member 20 along the rail 40.

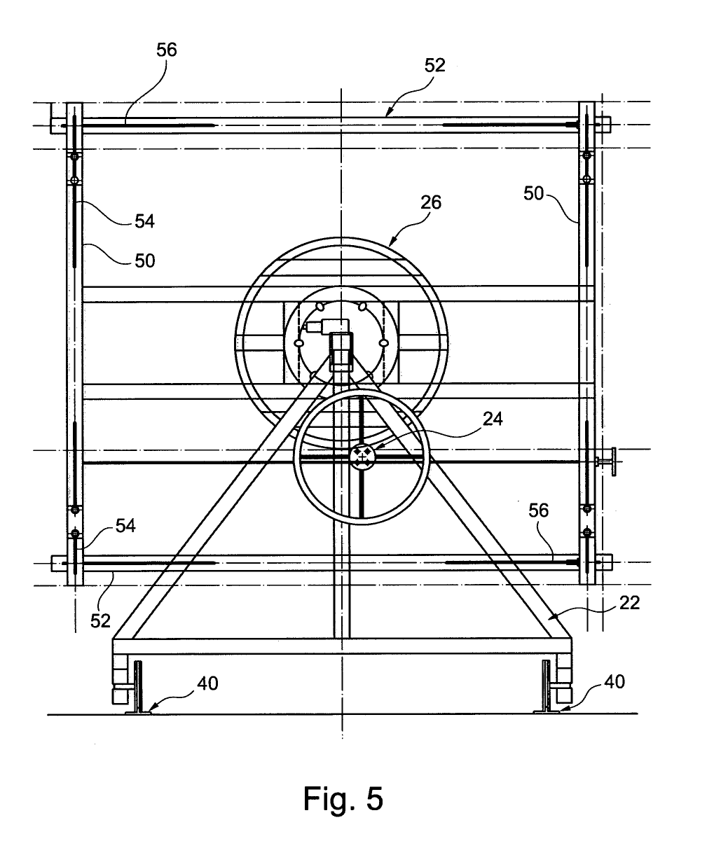

As shown best in FIG. 5, the first support member 20 comprises a number of support columns 50 and support beams 52. The support columns 50 have vertical slots 54 and the support beams 52 have horizontal slots 56 so that the distance between a pair of support columns 50, or between a pair of support beams 52 can be adjusted. The second support member 30 has a similar construction. This allows the jig 10 to be used in the construction of different modules which vary in their height or width.

The first and second support members each have a clamp (not shown) for clamping the respective frame member. The clamps are adapted to clamp two spaced apart columns of the frame members allowing connection of the columns by one or more lateral beams to form a planar frame. The two spaced apart planar frames can then be connected by longitudinal beams to form the box frame.

The jig 10 can include rotational positioning means (not shown) for accurately positioning the first and second support members. The jig 10 includes a brake 60 at each of the first and second support members for braking the rotating first and second support members at the desired rotational position.

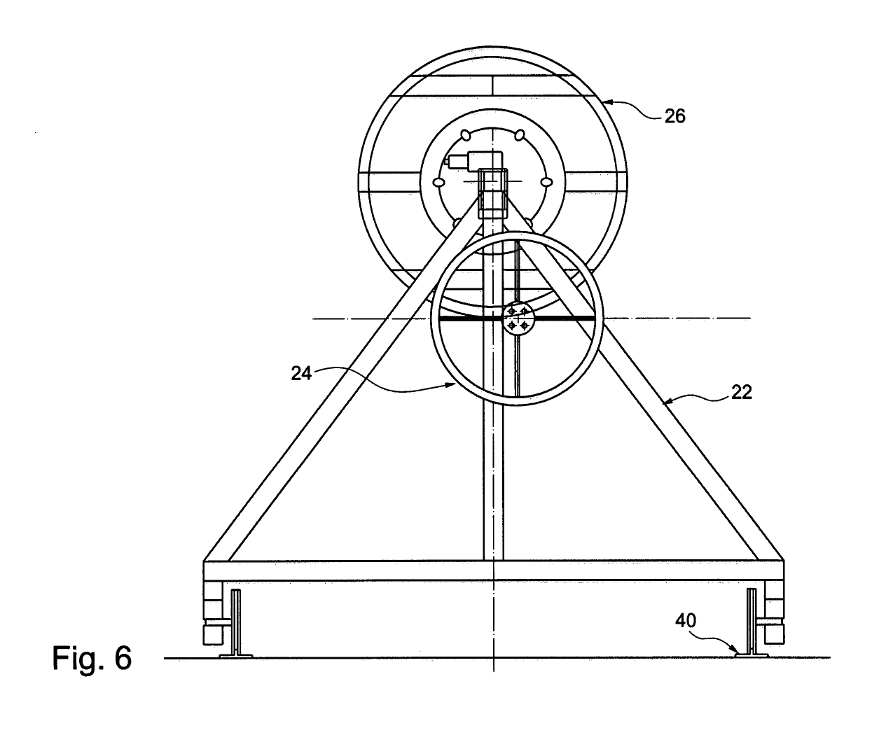

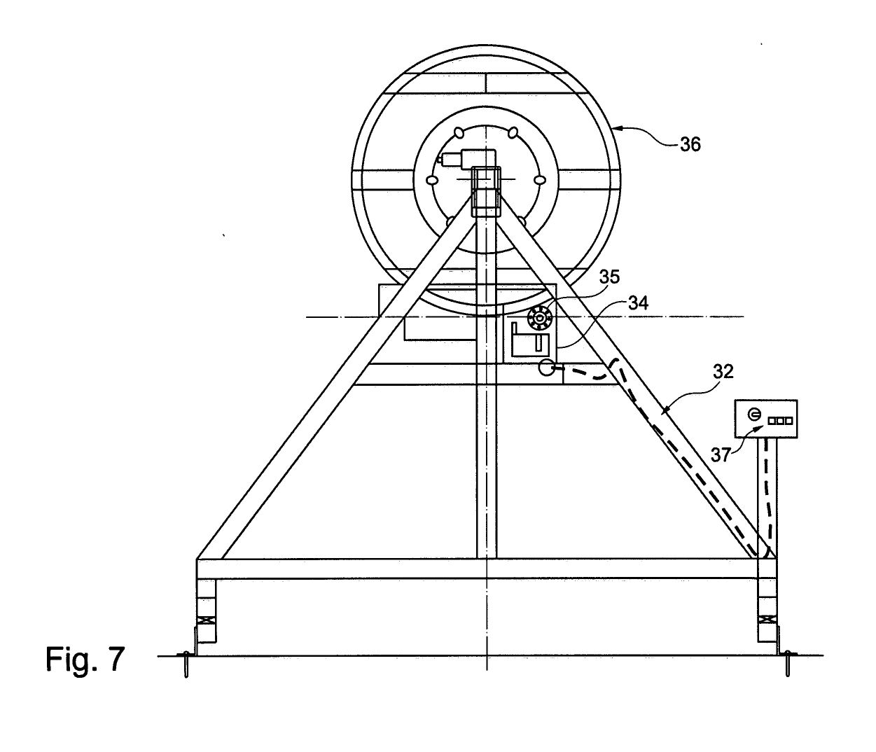

For clarity, the first and second support members and the first and second stand members are shown in FIGS. 6 and 7 respectively but the various support columns 50 and support beams 52 have been omitted.

Whilst specific embodiments of the present invention have been described above, it will be appreciated that departures from the described embodiments may still fall within the scope of the present invention.

1.-21. (canceled)

22. A support apparatus for assembling a frame comprising:
a first support member for supporting a first frame member;
a second support member spaced apart from the first support member for supporting a second frame member and allowing the first and second frame members to be connected by a third frame member; and
rotating means for rotating the first and second support members to allow the first and second frame members to be connected by a fourth frame member.

23. A support apparatus for assembling a frame according to claim 22, wherein the first support member is rotatably mounted to a first stand member; and
the second support member is rotatably mounted to a second stand member.

24. A support apparatus for assembling a frame according to claim 22, wherein the rotating means comprises a motor for rotating at least one of the first and second support members, and the rotating means is manually operated.

25. A support apparatus for assembling a frame according to claim 22, wherein the rotating means includes gearing.

26. A support apparatus for assembling a frame according to claim 22, wherein the support apparatus includes first adjusting means for adjusting the spacing between the first support member and the second support member; and
one of first and second stand members have a fixed position and at least one of the first and second stand members are movable in a first direction towards and away from the other of the first and second support members.

27. A support apparatus for assembling a frame according to any preceding claim 22, wherein at least one of first and second stand members are rollable or slidable in the first direction.

28. A support apparatus for assembling a frame according to claim 22, wherein at least one of the first and second stand members are rollable along a rail extending in the first direction.

29. A support apparatus for assembling a frame according to claim 22, wherein the first support member includes a first clamp for clamping the first frame member.

30. A support apparatus for assembling a frame according to claim 22, wherein the first support member is adapted to clamp two spaced apart columns of the first frame member allowing connection of the columns by one or more beams.

31. A support apparatus for assembling a frame according to claim 22, wherein the first clamp comprises two spaced apart clamping teeth and the distance between the clamping teeth is adjustable; and wherein one or more of the clamping teeth are mounted to slots provided at the first support member such that moving the or each clamping tooth along the slot adjusts the distance between the clamping teeth.

32. A support apparatus for assembling a frame according to claim 22, wherein the second support member includes a second clamp for clamping the second frame member.

33. A support apparatus for assembling a frame according to claim 22, wherein the second support member is adapted to clamp two spaced apart columns of the second frame member allowing connection of the columns by one or more beams.

34. A support apparatus for assembling a frame according to claim 22, wherein the second clamp comprises two spaced apart clamping teeth and the distance between the clamping teeth is adjustable

35. A support apparatus for assembling a frame according to claim 22, wherein one or more of the clamping teeth are mounted to slots provided at the second support member such that moving the or each clamping tooth along the slot adjusts the distance between the clamping teeth and the slots provide second adjusting means.

36. A support apparatus for assembling a frame according to claim 22, wherein the support apparatus includes rotational positioning means.

37. A support apparatus for assembling a frame according to claim 22, wherein the support apparatus includes braking means for braking the rotating first and second support members.
